(19) United States
(12) Patent Application Publication
(10) Pub. No.: US 2019/0102718 A1
(43) Pub. Date: Apr. 4, 2019

(54) TECHNIQUES FOR AUTOMATED SIGNAL AND ANOMALY DETECTION

(71) Applicant: Oracle International Corporation, Redwood Shores, CA (US)

(72) Inventors: Vikas Agrawal, Hyderabad (IN); Ananth Venkata, San Ramon, CA (US); Naren Chawla, Pleasanton, CA (US); Balaji Krishnan, Fremont, CA (US); Renduchintala Sri Venkata Nageswara Sharma, Bengaluru (IN)

(73) Assignee: Oracle International Corporation, Redwood Shores, CA (US)

(21) Appl. No.: 16/145,963

(22) Filed: Sep. 28, 2018

Related U.S. Application Data
(60) Provisional application No. 62/736,574, filed on Sep. 26, 2018.

(30) Foreign Application Priority Data
Sep. 29, 2017 (IN) 201741034643

(51) Int. Cl. G06Q 10/06; G06N 7/00; G06F 9/54

(52) U.S. Cl. CPC G06Q 10/06375; G06Q 10/067; G06F 9/542; G06N 7/005; G06Q 10/06315

(57) ABSTRACT

Predictive analysis techniques are described herein as applied to business variables. In some embodiments, a dynamic dependency model may be generated using a time-series data from a first time period. The model may define relationships between business variables during the first time period. A prediction of values of a variable (e.g., a business variable such as sales, revenue, attrition, or the like) can be generated based on the dynamic dependency model. The prediction of values may be for a second time period after the first time period. The actual values of the variable over the second time period can be obtained and compared to the predicted values to generate a statistical deviation. The statistical deviation may exceed a threshold and, a notification of the statistical deviation may be transmitted to a user device. The notification may alert the user that the variable is likely to miss the targeted/predicted value.

### CROSS-REFERENCES TO RELATED APPLICATIONS

This Application claims priority under 35 U.S.C. § 119 to India Provisional Patent Application number 201741034643, filed Sep. 29, 2017, entitled “SYSTEMS AND METHODS FOR AUTOMATED SIGNAL AND ANOMALY DETECTION,” and to U.S. Provisional Patent Application No. 62/736,574, filed Sep. 26, 2018, entitled “TECHNIQUES FOR AUTOMATED SIGNAL AND ANOMALY DETECTION,” each of which are incorporated herein in their entirety for all purposes.

### BACKGROUND

Proactively identifying anomalies in business variables (e.g., sales, revenue, inventory, and the like) is beneficial to companies. Existing systems may make forecasts on stationary single variables, but the real world is too complex to accurately predict variables based on such limited data. Further, existing systems may rely upon expectations manually entered by users, which is a tedious manual task that often results in inaccuracies. Further, individual value variations (e.g., year-to-date revenue is expected to be $2 Million on March 1 but is on track to be $1.8 Million) are difficult to identify, and identifying trend variations (e.g., trend acceleration such as revenue is expected to increase 5% quarter-over-quarter but is missing the expectation at an increasing rate) is exceptionally complex and existing systems do not accurately predict the value variations or the trend variations.

### BRIEF SUMMARY

The present disclosure relates generally to predictive analysis of variables using time-series data. More particularly, predictive analysis techniques are described as applied to business variables. Various inventive embodiments are described herein, including methods, systems, non-transitory computer-readable storage media storing programs, code, or instructions executable by one or more processors, and the like.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for predictive analysis. The method may include generating a dynamic dependency model using one or more time-series data sets. The dynamic dependency model may define relationships between variables related to an enterprise. The dynamic dependency model may be time-specific as based on the time-series data that is collected over a first time period. The method may also include generating a prediction of values of a variable (e.g., a business variable such as sales, revenue, attrition, or the like) based on the dynamic dependency model. The prediction of values may be over a second time period after the first time period (e.g., the first time period used to generate the dynamic dependency model includes last week and the prediction is for this week (the second time period)). The method may also include obtaining the actual values of the variable over the second time period. The method may also include comparing the predicted values with the actual values to generate a statistical deviation, including but not limited to differencing of definite integrals and of nth order derivatives (the statistical deviation may be used to determine how far the actual values deviate from the expected values based on the dynamic dependency model). The method may also include determining that the statistical deviation exceeds a dynamically determined threshold (e.g., the actual values are more than two standard deviations from the predicted values). The method may also include transmitting a notification of the statistical deviation to a user device. The notification may alert the user that the variable is on track to miss the targeted/predicted value. Other embodiments of this aspect include corresponding computer systems, apparatus, and computer programs recorded on one or more computer storage devices, each configured to perform the actions of the methods.

Implementations may include one or more of the following features. Optionally, determining that the statistical deviation exceeds the threshold may include generating a second prediction of values of the variable over a third time period (e.g., next week that ends the month) using the dynamic dependency model. A target value of the variable at the end of the third time period may be generated based on the dynamic dependency model. A third prediction of the values of the variable may be generated over the third time period using the actual values of the variable over the second time period to generate the third prediction. A predicted value of the first variable at the end of the third time period may also be generated based on the actual values of the variable over the second time period. The difference between the target value and the predicted value can be analyzed to determine if the difference exceeds a threshold. A confidence interval for the difference may be generated (based on the divergence of the distribution of the function based on the prediction from the dynamic dependency model can be divided by the integral of the function based on the prediction from the dynamic dependency model with an autoregressive integrated moving average (ARIMA) model of the actual values of the variable of interval to get a confidence interval. The notification can include a message that tells the user, for example in a natural language message, that the variable will miss its target and the amount by which it is expected to miss. The message may further include the percentage by which the variable might miss the predicted target. Optionally, the message may include a reason why the variable will miss its target (e.g., the message may provide information about one or more related values including a message reporting the difference and its confidence interval).

In some embodiments, the method may further include periodically updating the dynamic dependency model using a more recent set of time-series data. In some embodiments, a measure of cross-entropy is further used to generate the statistical deviation from the previous time periods. In some embodiments, generating the dynamic dependency model includes using a time window to limit the time-series data. Generating the dynamic dependency model may also include assigning a weight to each value of the time-series data, where the weight assigned to each value decreases as the age of the value increases (the value is further in the past). The method may also include using cross-entropy between the variables to find relationships between combinations of the variables. Implementations of the described techniques may include hardware, a method or process, or computer software on a computer-accessible medium.

The foregoing, together with other features and embodiments will become more apparent upon referring to the following specification, claims, and accompanying drawings.

### BRIEF DESCRIPTION OF THE DRAWINGS

FIG. 1 is a simplified block diagram of a distributed environment incorporating an exemplary embodiment.

FIG. 2 depicts a simplified flowchart depicting a process for predictive analysis according to certain embodiments.

FIG. 3 depicts a simplified flowchart depicting another process for predictive analysis according to certain embodiments.

FIG. 4 depicts a graph to depict deviations between received data and predicted data according to certain embodiments.

FIG. 5 depicts a simplified diagram of a distributed system for implementing an embodiment.

FIG. 6 is a simplified block diagram of a cloud-based system environment in which various storage-related services may be offered as cloud services, in accordance with certain embodiments.

FIG. 7 illustrates an exemplary computer system that may be used to implement certain embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to predictive analysis of variables using time-series data. More particularly, predictive analysis techniques are described as applied to business variables. Various inventive embodiments are described herein, including methods, systems, non-transitory computer-readable storage media storing programs, code, or instructions executable by one or more processors, and the like.

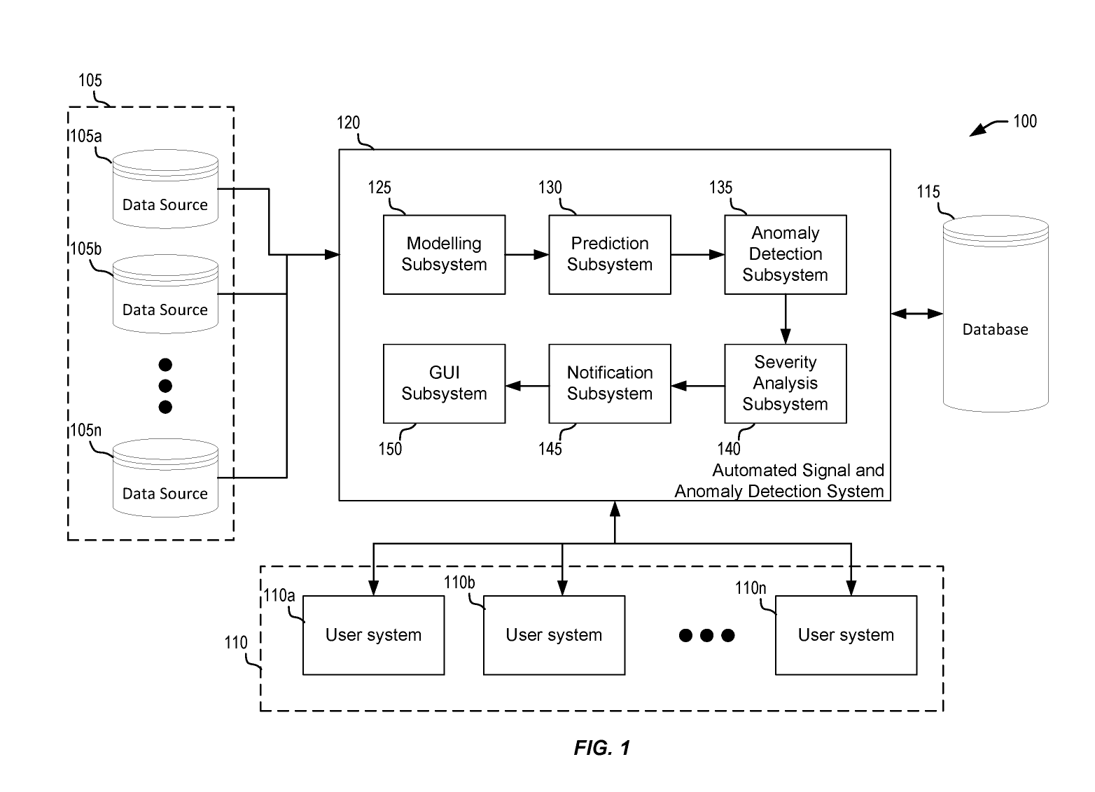

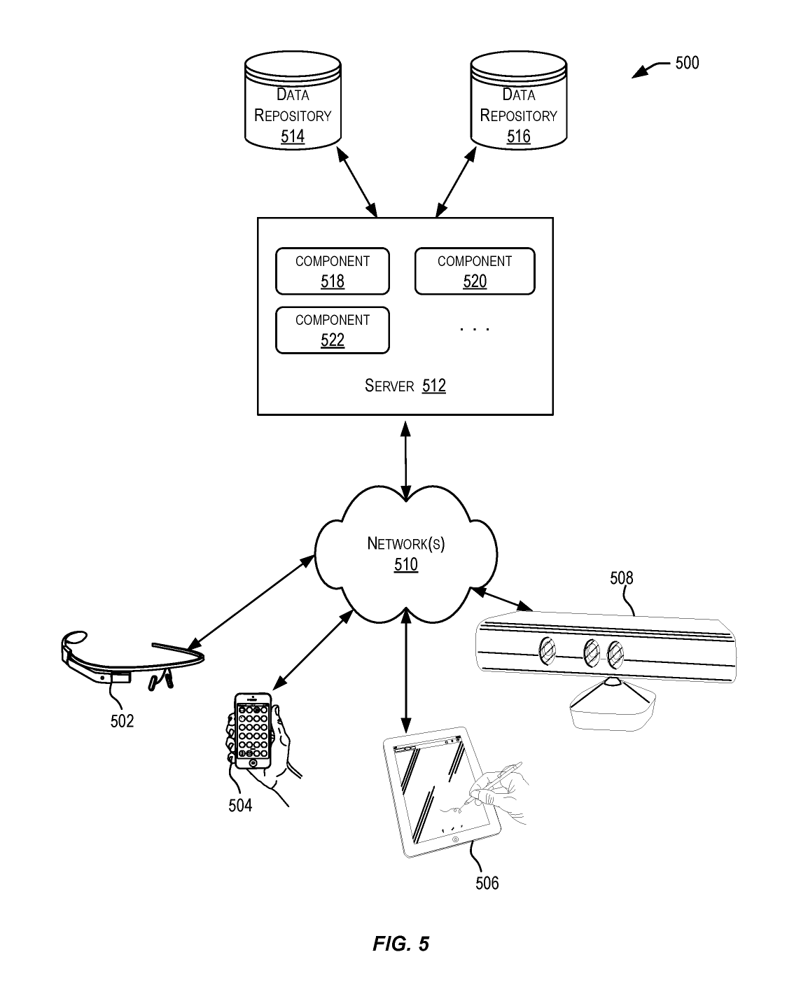

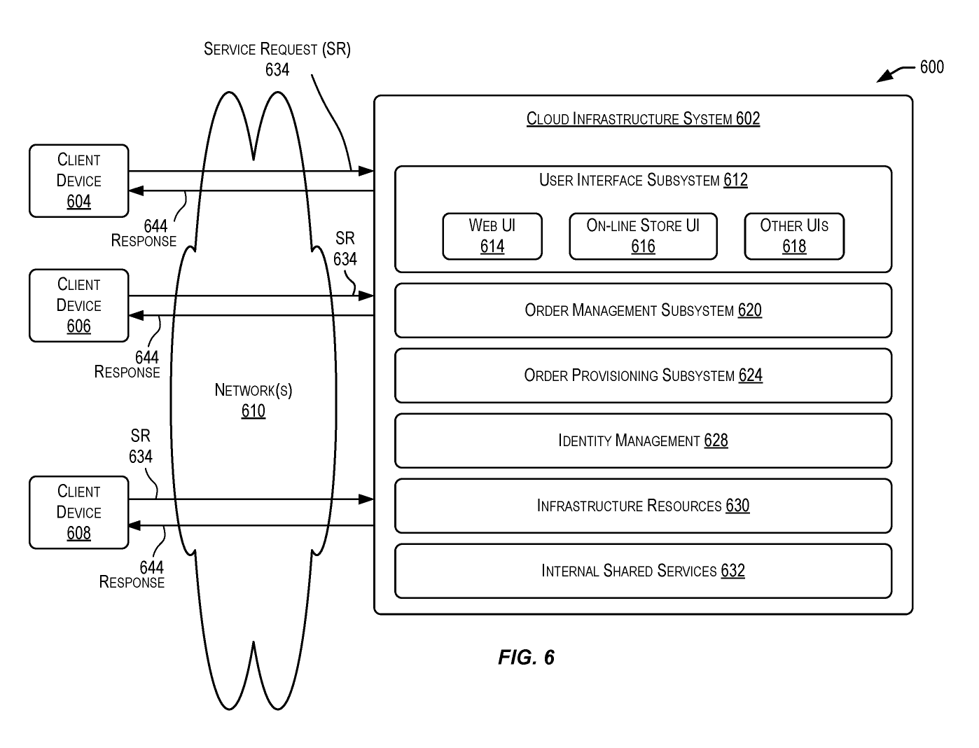

FIG. 1 is a simplified block diagram of a distributed environment 100 incorporating an exemplary embodiment. Distributed environment 100 may comprise multiple systems communicatively coupled to each other via one or more communication networks, such as network 510 or network 510 of FIGS. 5 and 6. The systems in FIG. 1 include one or more data processing systems (automated signal and anomaly processing system) 120, one or more user systems 110, one or more data sources 105, and a database 115 (or data store, in general) communicatively coupled to each other via one or more communication networks. Distributed environment 100 depicted in FIG. 1 is merely an example and is not intended to unduly limit the scope of claimed embodiments. One of ordinary skill in the art would recognize many possible variations, alternatives, and modifications. For example, in some implementations, distributed environment 100 may have more or fewer systems or components than those shown in FIG. 1, may combine two or more systems, or may have a different configuration or arrangement of systems.

Data sources 105, may include any number of data sources 105 that store or provide time-series data for an enterprise. Each of the data sources 105 may store or provide data relevant for performing predictive analysis of the variables relevant to the enterprise. For example, one or more data sources 105 may include time-series data regarding sales (e.g., a sales system), revenue, inventory (e.g., an inventory control system), headcount (e.g., attrition, hiring, and other employment related information), supply (e.g., a supply chain management system), and the like. The time-series data from the data sources 105 may be received, for example, as a stream of data as the data is generated and/or from a database as a batch of data. The time-series data may include information about one or more business variables relevant to the enterprise such as, for example, sales, revenue, headcount, shipping, vendor related information (e.g., vendor downtime), factory downtime, costs, demand, orders, profits, production, employee availability, and the like. Each of the business variables may be analyzed as described herein. While described in the context of enterprise business variables, the described systems and techniques may be used for predictive analysis of any type of variables based on time-series data relevant to the variable of interest.

User systems 110 may be any suitable computer systems that may be used by a user to interact with data processing system 120. For example, predictive analysis results generated by data processing system 120 may be transmitted to a user system 110 and may be output to a user via a graphical user interface (GUI) displayed by the user system 110. A user may also use a user system 110 to provide inputs to data processing system 120, where the inputs may be used by data processing system 120 as parameters for the analysis performed by data processing system 120. For example, the user may select specific parameters or configurations to modify the displayed information in the GUI. User systems 110 may be computer system 1000 of FIG. 10. Although three user systems 110 are shown in FIG. 1, this is not intended to be limiting in any manner. In alternative embodiments, any number of user systems 110 may be supported by distributed system 100.

Database 115 may be any suitable database (or data store) for storing data used by data processing system 120 for performing predictive analysis. In certain embodiments, the results of the predictive analysis may be stored in database 115. In certain embodiments, data used to generate GUIs by GUI subsystem 150 and/or notifications generated by notification subsystem 145 may be stored in database 115.

Data processing system 120 may be implemented using one or more suitable computer systems, such as, for example, one or more of computer system 500 of FIG. 5. In the embodiment depicted in FIG. 1, data processing system 120 includes a modelling subsystem 125, prediction subsystem 130, anomaly detection subsystem 135, severity analysis subsystem 140, notification subsystem 145, and graphical user interface subsystem 150. While specific subsystems are depicted within data processing system 120, more or fewer subsystems may be used to incorporate the described functionality without impacting the scope of this disclosure.

Modelling subsystem 125 may be implemented using software executed by one or more processors, hardware, firmware, or combinations thereof, and is configured to collect data from data sources 105. Modelling subsystem 125 may generate a dynamic dependency model. A dynamic dependency model may be a model that defines relationships between business variables related to the enterprise. The dynamic dependency model may define the relationship between the variables as well as the time delay of the relationship. For example, the dynamic dependency model may define a relationship between factory downtime and supply such as that an increase in factory downtime results in a decrease in supply seen two days later. The model may be generated based on time-series data. The model may be dynamically updated over time. The model may be based on recent time-series data collected related to the variables. As the time-series data becomes stale (old, further past in time), new (more current) time-series data may be used to refresh the dynamic dependency model, for example, periodically.

To generate the dynamic dependency model, the modelling subsystem 125 may collect the time-series data from data sources 105. To ensure that the data used for the model is relevant, old data is “forgotten.” For example, a time window is used to limit the amount of time-series data considered for any given model. The time window may be configured automatically by data processing system 120 or configured by a user. The time window may define a first time frame (e.g., the past week, the past month, the past day, the past hour, or any other suitable time frame, which may depend on the frequency of data values in the time-series). Any data values in the time-series data that occur previous to the first time frame are “forgotten.”

Modelling subsystem 125 may collect time-series data for a number of business variables as described above. The time-series data for each variable may be comprised of multiple data values for each variable over the first time frame. Modelling subsystem 125 may also apply a weight to each data value in the time-series data from the first time frame such that older data values have a lower weight than newer data values. The weight may be assigned, for example, linearly decaying as the values get older or exponentially decaying as the values get older. This weighting scheme can be considered gradual “forgetting.” By giving less weight to older data, it becomes less relevant in the calculation until it, on a future refresh of the model, may be completely forgotten by falling outside of the time frame used to generate the refreshed model.

After applying the weights, modelling subsystem 125 may have a set of weighted data values for each variable having data in the time-series data from the first time frame. Modelling subsystem 125 may use time shifting to compare each set of weighted data values for each variable to each other set of weighted data values for the other variables to find relationships between the variables. This time shift analysis may, for example, use the known Granger causality test to find the causal relationships. The analysis may be a many-to-many analysis to find related variables, the impact of the relationship, and the time shift associated with the relationship (e.g., a 5% decrease in costs may result in a 3% increase in profit seen 2 weeks later).

While this dynamic dependency model may be valid for the recent data set, the world is non-stationary, so the variables, their relationships, and the extent of the relationships may change over time. Accordingly, the dynamic dependency model may be refreshed periodically (e.g., daily, weekly, monthly, and/or the like) to ensure that modeled relationships are current and accurate. The frequency of the periodic refresh may be automatically set by the data processing system 120 based on how quickly the distribution of data is changing over time or, in some embodiments, the frequency of the periodic refresh may be configured by a user.

Prediction subsystem 130 may be implemented using software executed by one or more processors, hardware, firmware, or combinations thereof, and is configured to collect data from data sources 105. Prediction subsystem 130 may use the dynamic dependency model generated by modelling subsystem 125 to generate predictions. The distribution of predictions may be considered as a source for dynamic thresholds derived based on statistical process control. The thresholds are dynamic because the predictions based on the dynamic dependency model may change as the dynamic dependency model is modified, and the predictions generated by prediction subsystem 130 are the expected values for each variable. Predictions for a variable may be generated for a second time frame (e.g., this week when the first time frame used to generate the model was last week) using the dynamic dependency model. For example, the relationships defined in the dynamic dependency model may indicate that a decrease in revenue results in a decrease in production seen a week later. Note that while this example relationship may seem counter-intuitive, the modelling subsystem 125 may identify relationships that a human may not even consider (these counter-intuitive relationships may later be explained by seeking the variables that contributed to the prediction). Continuing the example, prediction subsystem 130 may identify a decrease in revenue in the time-series data near the end of time frame 1, which may be used to predict values for production in time frame 2. This prediction may be done using the dynamic dependency model and available time-series data for all variables to generate predictions for each variable. The output of prediction subsystem 130 may be predicted data values for each variable over the second time frame. The predicted data values for each variable may include multiple values over the second time frame, a single data value for each variable, or any combination of such (e.g., a first variable may have a single data value predicted over time frame 2 while a second variable may have multiple data values predicted at various times during time frame 2).

Anomaly detection subsystem 135 may be implemented using software executed by one or more processors, hardware, firmware, or combinations thereof, and is configured to collect data from data sources 105. Anomaly detection subsystem 135 may use the predictions from prediction subsystem 130 over time frame 2 to identify anomalies. Anomaly detection subsystem 135 may collect time-series data for the variables of interest (e.g., some or all of the variables for which a prediction exists over time frame 2) over time frame 2. The actual data values collected over time frame 2 for a variable may be compared to the predicted values over time frame 2. If a deviation exists, an anomaly may be detected. For example, statistical test may be used to identify the deviation (e.g., a statistical deviation). Example tests may include the Kullback-Leibler Divergence Test, statistical process control methods, cross-entropy analysis, and the like. The statistical test may determine the threshold for the variable, targets for the variable, unpredictable trends, changes in past seasonality, increases, differences from expected values, and the like. For example, given a specific variable, predicted values may be generated using prediction subsystem 130 and actual data values may collected. If, for example, many or all of the actual data values are above (or below or outside) the range of or the distribution of predicted values, an anomaly may be detected. If, for example, a successive number of actual data values are beyond two or more sigma limits (standard deviations) away from the normal defined by the prediction, in the same direction, an anomaly may be detected. Variables for which an anomaly is detected may be further analyzed.

Severity analysis subsystem 140 may be implemented using software executed by one or more processors, hardware, firmware, or combinations thereof, and is configured to collect data from data sources 105. Severity analysis subsystem 140 may analyze the anomalies detected by anomaly detection subsystem 135. For example, anomaly detection system may determine that there is an anomaly with respect to a variable. Severity analysis system may determine the severity of the anomaly including, by how far the enterprise may miss the target/predicted value, the cause for missing the target, and a confidence interval indicating the confidence the model has that the enterprise will miss the target by the amount predicted.

Severity analysis subsystem 140 may analyze the severity based on a third time frame (e.g., next week). For example, severity analysis subsystem 140 may predict (or get a prediction from prediction subsystem 130) data values for the variable of interest during the third time frame. The predicted values may be based on the previously created dynamic dependency model, which gets updated over time, and the actual data values for all variables from time-series data collected, for example, to date. The prediction for the third time frame may indicate the expected values, including, in some embodiments, a predicted final value at the end of the third time frame. For example, an anomaly with respect to revenue may be detected by anomaly detection subsystem 135. Severity analysis subsystem 140 may predict data values for revenue over the third time frame using the dynamic dependency model and actual data values for all variables relevant based on the model. Severity analysis subsystem 140 may also predict data values for revenue over the third time frame based on actual data values for revenue over the second time frame. For example, if revenue data values during the second time frame (e.g., this week) have been flat or decreasing, the prediction based on the actual data values of revenue during the second time frame may also remain flat and/or decreasing.

Continuing with the revenue example, severity analysis subsystem 140 may determine that the data value for revenue at the end of the third time frame may be predicted (expected) based on the dynamic dependency model to be, for example, $10 Million (the target). Severity analysis subsystem 140 may also predict, based on the actual values for revenue over the second time frame that the data value for revenue at the end of the third time frame may be, for example, $9.6 Million. The difference of $400,000 (amount by which the target is missed) may be the deviation. The deviation may be considered severe enough to warrant a notification if, for example, it exceeds a threshold number or percentage or a standard deviation measure or a Mahalanobis distance measure defined by previous data. Further, a confidence interval associated with the deviation calculation can be generated. For example, the divergence between the distribution of the function generated by the predicted data values based on the model over the third time frame with the distribution of the function generated by the ARIMA predicted data values over the third time frame that are based on the actual values from the second time frame. The confidence value may also be used to determine whether a notification should be sent. For example, if the confidence interval overlap falls below or above a certain dynamically determined domain-specific range the notification may not be sent.

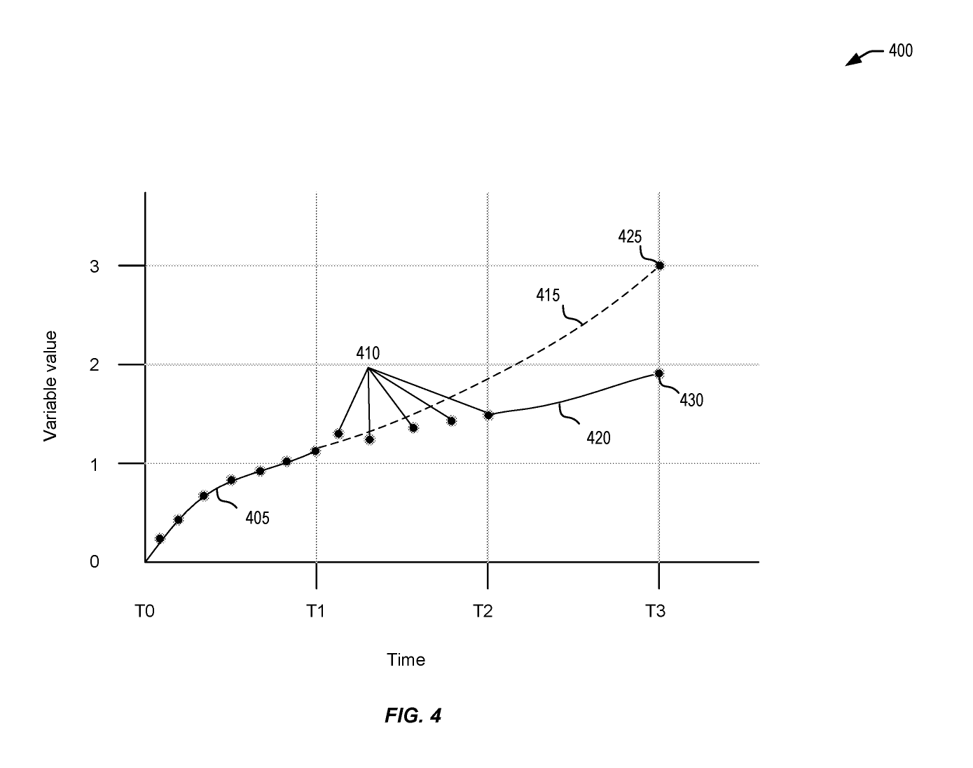

Notification subsystem 145 may be implemented using software executed by one or more processors, hardware, firmware, or combinations thereof, and is configured to generate notifications based on the severity analysis subsystem 140 outputs. For example, severity analysis subsystem 140 may output statistical deviations above a threshold that may be sufficient to generate a notification, which may be sent via short message service (SMS) messaging using natural language generation to users that are configured to receive such notifications. In some embodiments, the notifications may appear to the user on their graphical user interface when the user logs into the graphical user interface. For example, notifications may appear within, for example a graph such as graph 400 of FIG. 4 when a user logs into a user interface.

Graphical User Interface (GUI) subsystem 150 may be implemented using software executed by one or more processors, hardware, firmware, or combinations thereof, and is configured to generate a GUI for users of user system 110 to view the predictive analysis performed by the subsystems of data processing system 120 described above. For example, the graph 400 depicted in FIG. 4 may be displayed in a GUI for the user to see the predictions and the deviations. This information may be used by the user to accordingly act on the predictions to, for example, avoid missing targets.

Data processing system 120 depicted in FIG. 1 is merely an example and is not intended to be limiting. One of ordinary skill in the art would recognize many possible variations, alternatives, and modifications. For example, in some implementations, data processing system 120 may have more or fewer components than those shown in FIG. 1, may combine two or more components, or may have a different configuration or arrangement of components. While only one data processing system 120 is depicted in FIG. 1 for purposes of simplicity, this is not intended to be limiting. A typical distributed environment generally includes multiple data processing systems, each configured to execute one or more applications.

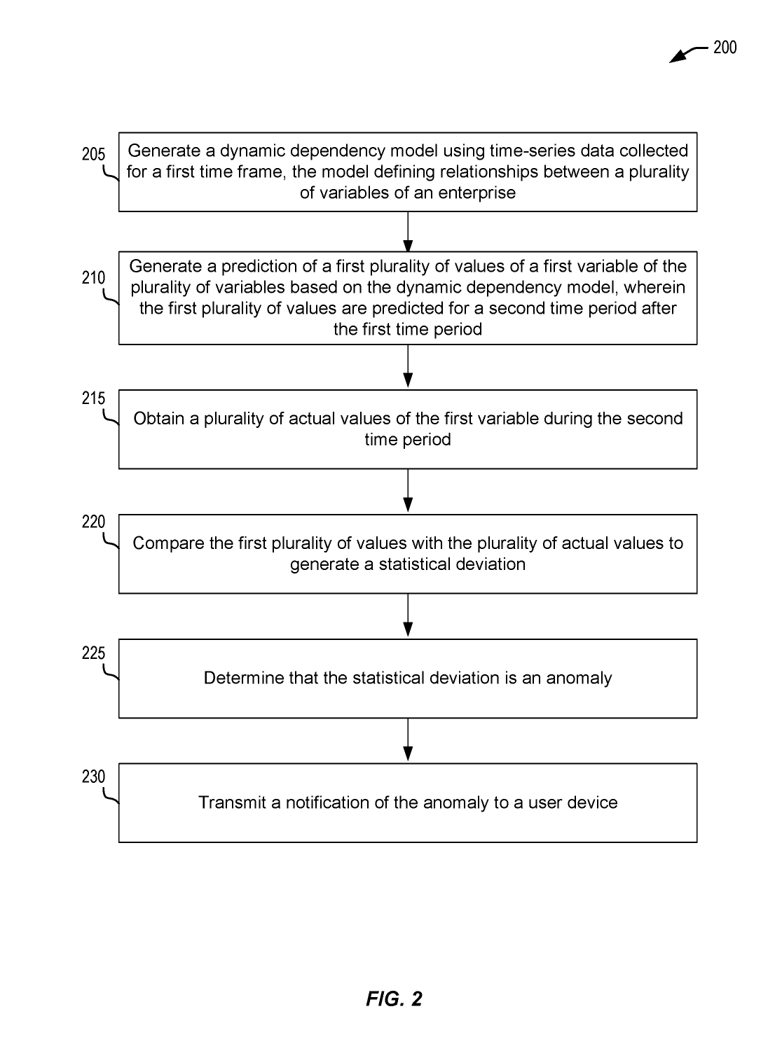

FIG. 2 depicts a simplified flowchart 200 depicting a process of predictive analysis according to certain embodiments. The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 1, the processing depicted in FIG. 2 may be performed by data processing system 120.

As shown in FIG. 2, at step 205, a computer system (e.g., data processing system 120) may generate a dynamic dependency model using time-series data collected over a first time frame, the model defining relationships between a plurality of variables embodying operations of an enterprise. For example, modelling subsystem 125 may generate a dynamic dependency model. The dynamic dependency model may define relationships between business variables (e.g., revenue, production, vendor downtime, external events such as weather, headcount, costs, and the like) for a time frame defined by the modelling subsystem 125. The time frame may be a selected window over which the data values for the variables may be collected and received in the time-series data. Data values outside of the time frame may be excluded to minimize the impact of old data. The dynamic dependency model may change over time, so recent data should be given a higher value or weight, which can be accomplished by assigning a higher weight to the data values that are more recent in time. The time-series data for each variable can be compared on a many-to-many basis to identify the relationships between the variables, the impact of one variable on another based on the relationship, and so forth. The relationships may be identified using the weighted data values from the time frame using, for example, the Granger causality test.

At step 210, a prediction of a first plurality of values of a first variable of the plurality of variables based on the dynamic dependency model can be generated by, for example, prediction subsystem 130. The prediction of the first plurality of values may be for a second time period, which is after the first time period. The prediction can be based on the dynamic dependency model and current time-series data for the various variables. The relationships between the variables and the current data may be used to predict the data values for the variables for the upcoming (second) time frame. During the second time frame, actual data values for the variables may then be collected at step 215.

At step 220, the first plurality of values can be compared with the plurality of actual values to generate a statistical deviation using divergence tests. For example, anomaly detection module 135 may identify anomalies based on a statistical deviation between the actual values obtained and the predicted values for any given variable. When the deviation becomes significant enough based on Western Electric rules or based on distance from the distribution in a domain dependent manner (in some domains, deviations beyond six sigma are important while in other domains, going beyond two sigma is cause for concern), the deviation may be flagged as an anomaly at step 225. The detection process remains dynamic by generating the variable distribution dynamically to determine what constitutes deviation and what constitutes normal.

At step 230, a notification of the anomaly can be transmitted to a user device by, for example, notification module 145.

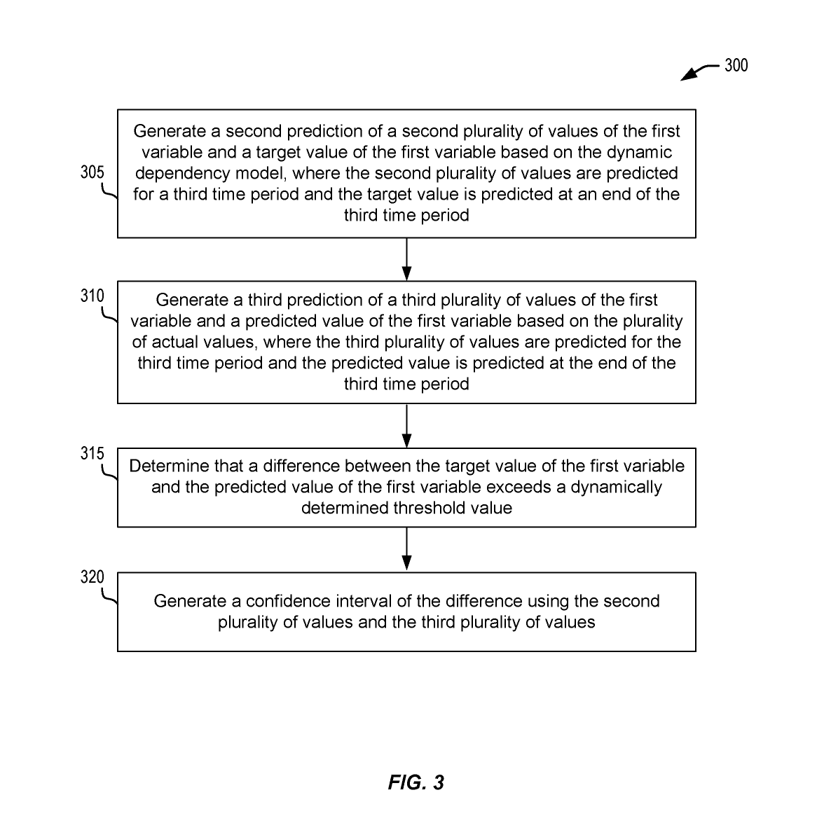

FIG. 3 depicts a simplified flowchart 300 depicting a process of predictive analysis according to certain embodiments. The processing depicted in FIG. 3 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 1, the processing depicted in FIG. 3 may be performed by data processing system 120.

The flowchart 300 may provide additional detail for step 225 of FIG. 2. Specifically, the severity detection subsystem 140 may, at step 305 generate a second prediction of a second plurality of values of the first variable and a target value of the first variable based on the dynamic dependency model, where the second plurality of values are predicted over a third time period and the target value is predicted at an end of the third time period. For example, if revenue is detected as an anomaly, over the third time period (e.g., next month, next week, next quarter, tomorrow, or any suitable time frame), a prediction of revenue can be generated based on the dynamic dependency model and current values for all variables with a relationship to revenue based on the dynamic dependency model. The ending value for the third time frame may also be predicted (the target value).

At step 310, a third prediction of a third plurality of values of the first variable and a predicted value of the first variable may be generated based on the plurality of actual values, where the third plurality of values are predicted over the third time period and the predicted value is predicted at the end of the third time period. In other words, using the actual data values from the second time frame for revenue, which may indicate a different trend than that expected based on the dynamic dependency model, data values for revenue for the third time frame are predicted and a final value is predicted.

At step 315, a difference between the target value of the first variable and the predicted value of the first variable may be determined to exceed a dynamically determined threshold value based on, for example, model output distribution from a boundary condition dependent Monte-Carlo simulation. For example, the predicted final value may be compared to the target value to determine whether the enterprise will miss the target and by how much. Further, the reasons for missing the target may be identified based on the dynamic dependency model.

At step 320, a confidence interval of the prediction that the target will be missed can be calculated. For example, the divergence of the distribution of the function generated by the predicted data values based on the model over the third time frame with the distribution of the function generated by the predicted data values over the third time frame that are based on the actual values from the second time frame.

As indicated above, the particular sequence or order of steps depicted in FIG. 2 or 3 is not intended to be limiting. In certain alternative embodiments, the steps may be performed in some different order or some steps may also be performed in parallel. For example, while steps 305 and 310 are shown as occurring in a particular order in flowchart 300 in FIG. 3, this is not intended to be limiting. In alternative embodiments, these can occur in any order. In yet other embodiments, the processing in steps 305 and 310, for example, may overlap or may be performed in parallel.

FIG. 4 depicts a graph 400 for depicting the actual values of a variable in relation to predicted values of the variable. For example, time frame 1 as shown between T0 and T1 may have actual value data points resulting in function 405. This may be the actual data values from the first time-series of data for the variable. This actual data from time frame 1, along with time-series data for other variables, may be used to generate the dynamic dependency model as described with respect to modelling subsystem 125 of FIG. 1.

Predicted function 415 may represent the function used to obtain values predicted by the dynamic dependency model in time frame 2 (shown between T1 and T2) and time frame 3 (shown between T2 and T3). Note that while time frame 1, time frame 2, and time frame 3 all appear to be equal in graph 400, the amount of time used for any given time frame may differ from each other time frame in some embodiments. The predicted function 415 may be generated by, for example, prediction subsystem 130 as described with respect to FIG. 1. Target value 425 may also be predicted based on the dynamic dependency model. This is the final target value 425 for the variable at T3. In this example, the value is approximately 3.

Data values 410 may be actual data values obtained for the variable during time frame 2. These data values may be used to generate a second prediction function 420 over time frame 3. The second prediction function 420 may be generated by, for example, anomaly detection subsystem 135 as described with respect to FIG. 1. Predicted value 430 may be the final value predicted at T3 using the actual values of the variable over the second time frame to make the prediction. In this example, predicted value 430 may be approximately 1.95.

As described above, the severity analysis subsystem 140 may compare the target value 425 with the predicted value 430 to determine whether the anomaly is severe enough to warrant notification. A notification of the deviation (difference) between the target value 425 and the predicted value 430 may be sent to a user device via, for example, SMS messaging. A confidence of the prediction may be generated and sent as well. Further, the reason for the deviation may be identified based on the dynamic dependency model and provided to the user.

In some embodiments, a graph like graph 400 may be available to a user using a user interface produced by, for example, GUI subsystem 150 of FIG. 1. The user may have the option to select the variable to view, the time frames for viewing, and so forth.

As described above, significant improvements are realized by the disclosed embodiments. Relevance of past data is determined by a combination of statistical cross-entropy, relative entropy (Kullback-Leibler Divergence) and wavelet transform differential in the apparently related/unrelated time series chunks from different time windows within the same time series. This relevance measure is used to determine which of the time window chunks of the past should be included or given lower weightage. If the frequencies but not the magnitude (mean, deviation) of certain events change, linear damping (assigning weights linearly) may be used. On the other hand, if both frequencies and the amplitudes based on mean dramatically change, exponential damping (assigning weights exponentially) may be used. Further, if the frequencies, means and deviations/ranges of events change, windowing techniques may be used. What is determined to be significant enough degree of change in each of frequency, and amplitude variations are determined by whether the distributions overlap less than the equivalent of one deviation, two deviations, or three deviations in each measure and equivalent Bayesian probabilities.

Cross-entropy is an information measure to detect how much information can be obtained about one series from another. Kullback-Leibler divergence (also called relative entropy) is a measure of how one probability distribution diverges from a second, expected probability distribution. Each wavelet measurement (the wavelet transform corresponding to a fixed parameter) may provide information about the temporal extent of the signal, as well as about the frequency spectrum of the signal.

Time shifting, windowing and linear/exponential weighting techniques are used to generate the dynamic dependency model. Gradual forgetting as described above in addition to Temporal Causal Models by weighting the samples from the past significantly less than current samples, using a linear or exponential fading factor (adjusted by learning from dataset for best fit in Temporal Causal Models) multiplied with the value of the variable when calculating any aggregation of the variable is used to obtain the most accurate model.

Extension of the dynamic dependency models to non-stationary time series (NSTCM) is realized by first finding the relevant past (as described above) for each input variable. This extension may reduce the compute complexity of the models by as much as 65% depending on time series pruning in the data. The extension further increases the accuracy of trends/anomaly detection between 15%-75%, with the upper accuracy improvement occurring for cases with dramatic changes in business process (90% shift) being modeled over time, and the lower bound occurring for cases with up to 20% shifts.

In some embodiments, a time dependent dynamic network graph of time-shifted cyclic relationships based on a definition of Granger causality that if a combination of time-shifted X and Y better predicts Y, then X is a cause of Y (parent-child/causal) may be generated. Generation of the dynamic network graph may be mathematically akin to inferring a delay-differential equation mathematical model of the phenomenon we model, without knowing the actual differential equations or relationships. Using the time shifted time series relationships modeled in the dynamic dependency model allows for accurate projection (prediction) of the upcoming values for the variables of interest.

The impact on variables of interest may be accurately determined based on the calculated significance of departure from the dynamic dependency model and using the past benchmarks. Further, the real-world significance of the departure may be determined and reported to allow users to preemptively act to avoid missing targets and other negative business outcomes. The model forecast/prediction of median and deviation serves as a dynamic thresholding mechanism, updating expected values based on actual, current data, rather than based on error-prone manual user entry.

As an example, at each current time instant, the last n (e.g., 10) predicted outcome variable points may be used. In some embodiments, whether the actual outcome points were either outliers or determiners of a trend may be determined by determining how many of the n (e.g., ten) last actual data points fall on the same side of the median of the distribution represented by the last m (e.g., 30) predicted data points. In some embodiments, whether the actual outcome points were either outliers or determiners of a trend may be determined by determining how many of the last n actual data points fall outside two sigma limits in the same direction of the median of the distribution represented by the last m predicted data points. In some embodiments, whether the actual outcome points were either outliers or determiners of a trend may be determined by determining how many of the last n actual data points keep moving across the boundary set by the dynamic dependency model distribution.

In some embodiments, trends (e.g., percent changes over time rather than specific data points in time) may be detected. Trends may be detected by comparing derivatives of the last n points with respect to the predicted derivatives distribution of the NSTCM (dynamic dependency) model.

In some embodiments, a risk of missing historical or predicted targets may be determined by using definite integration of the model with all variables changing over time, and comparing with an ordinary trendline fit to the last n points of the actual reality fed data. This difference alerts the end user about a risk to revenue miss, for example. Temporal cyclic relationships may be used between the outcome variable (KPI) (e.g., sales) and our target variable (e.g. revenue or profit target). If this integration leads to missing pre-specified targets, the excursion may be flagged as a risk (in some cases a major risk). The probability of meeting the target is based on the spread of the derivatives at this point and in the predicted derivatives. For example, when probability of meeting the threshold falls below a certain probability (e.g. there is less than 20% probability of meeting a 5% increase in revenue quarter over quarter).

In some embodiments, humans may enter threshold, for example, in a user interface. The entered thresholds may be used to identify anomalies and alert the user when values deviate from the user's configured thresholds.

In some embodiments, a visualization of the incoming stream data as it updates, flag points, trends and goal risk anomalies, and the like may be provided in a user interface. For example, the graph 400 may be provided with additional values marked and/or highlighted for the user. In some embodiments, the user interface may provide natural language text and visual highlighting of the anomaly points.

Improvements in some embodiments further include providing an explanation for each pre-selected KPI (variable of interest) with specific dimensions or attributes that have high information theoretic content based on locally faithful optimization based model interpretations (such as our algorithm for shortest path gradient ascent search) run on top of complex machine learning models. These explanations are used to create a bounded Monte-Carlo simulation using variables that are controllable by the decision-makers (users) to find a list of potential shortest paths to fixing an anomalous trend or risk to an expected target, and these paths are provided to the end user for decision-making. Select KPIs which have statistically significant change, and the maximal entropy change (information increase) over periods of interest. In some embodiments, the variables (KPIs) may be sorted by practical significance (e.g. z-score % change) and output to a user for analysis. In some embodiments, display of information about the variable (KPIs) may be provided using KPI cards, and may include dimensions and/or attributes of the KPI, which may be selected for display based on having the highest entropy change contribution.

The infrastructure described above can be implemented in various different environments including a cloud environment (could be various types of clouds including private, public, and hybrid cloud environments), on-premises environment, a hybrid environment, and the like.

FIG. 5 depicts a simplified diagram of a distributed system 500 for implementing an embodiment. In the illustrated embodiment, distributed system 500 includes one or more client computing devices 502, 504, 506, and 508, coupled to a server 512 via one or more communication networks 510. Clients computing devices 502, 504, 506, and 508 may be configured to execute one or more applications.

In various embodiments, server 512 may be adapted to run one or more services or software applications that enable predictive analysis. For example, data processing system 120 may be server 512.

In certain embodiments, server 512 may also provide other services or software applications that can include non-virtual and virtual environments. In some embodiments, these services may be offered as web-based or cloud services, such as under a Software as a Service (SaaS) model to the users of client computing devices 502, 504, 506, and/or 508. Users operating client computing devices 502, 504, 506, and/or 508 may in turn utilize one or more client applications to interact with server 512 to utilize the services provided by these components.

In the configuration depicted in FIG. 5, server 512 may include one or more components 518, 520 and 522 that implement the functions performed by server 512. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, and/or 508 to access data processing system 120 in accordance with the teachings of this disclosure. A client device may provide an interface that enables a user of the client device to interact with the client device. The client device may also output information to the user via this interface. Although FIG. 5 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device; Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 510 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 510 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 512 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 512 can include one or more virtual machines running virtual operating systems, or other computing architectures involving virtualization such as one or more flexible pools of logical storage devices that can be virtualized to maintain virtual storage devices for the server. In various embodiments, server 512 may be adapted to run one or more services or software applications that provide the functionality described in the foregoing disclosure.

The computing systems in server 512 may run one or more operating systems including any of those discussed above, as well as any commercially available server operating system. Server 512 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 512 may include one or more applications to analyze and consolidate data feeds and/or event updates received from users of client computing devices 502, 504, 506, and 508. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 512 may also include one or more applications to display the data feeds and/or real-time events via one or more display devices of client computing devices 502, 504, 506, and 508.

Distributed system 500 may also include one or more data repositories 514, 516. These data repositories may be used to store data and other information in certain embodiments. For example, one or more of the data repositories 514, 516 may be used to store the described time-series data and/or the predictive analysis outputs and data used by data processing system 120. Data repositories 514, 516 may reside in a variety of locations. For example, a data repository used by server 512 may be local to server 512 or may be remote from server 512 and in communication with server 512 via a network-based or dedicated connection. Data repositories 514, 516 may be of different types. In certain embodiments, a data repository used by server 512 may be a database, for example, a relational database, such as databases provided by Oracle Corporation® and other vendors. One or more of these databases may be adapted to enable storage, update, and retrieval of data to and from the database in response to SQL-formatted commands.

In certain embodiments, one or more of data repositories 514, 516 may also be used by applications to store application data. The data repositories used by applications may be of different types such as, for example, a key-value store repository, an object store repository, or a general storage repository supported by a file system.

In certain embodiments, the predictive analysis functionality described in this disclosure may be offered as services via a cloud environment. FIG. 6 is a simplified block diagram of a cloud-based system environment in which predictive analysis services may be offered as cloud services, in accordance with certain embodiments. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 512. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other embodiments, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative embodiments.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the customer's own on-premise servers and systems. The cloud service provider's systems are managed by the cloud service provider. Customers can thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, Calif., such as middleware services, database services, Java cloud services, and others.

In certain embodiments, cloud infrastructure system 602 may provide one or more cloud services using different models such as under a Software as a Service (SaaS) model, a Platform as a Service (PaaS) model, an Infrastructure as a Service (IaaS) model, and others, including hybrid service models. Cloud infrastructure system 602 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 602. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 602. Cloud infrastructure system 602 then performs processing to provide the services requested in the customer's subscription order. For example, the customer may subscribe to predictive analysis services provided by cloud infrastructure system 602. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public customer, where the customer can be an individual or an enterprise. In certain other embodiments, under a private cloud model, cloud infrastructure system 602 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other embodiments, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602. For example, a user may use a client device to request a user interface for viewing the predictive analysis output and/or results described herein and/or other data related to the enterprise in a dashboard that includes the predictive analysis outputs along with other metric indicators as described in this disclosure.

In some embodiments, the processing performed by cloud infrastructure system 602 for providing predictive analysis-related services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the anomalies described herein. The time-series data can become a large data set over time, requiring big data analysis. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain embodiments, to facilitate efficient provisioning of these resources for supporting the various cloud services provided by cloud infrastructure system 602 for different customers, the resources may be bundled into sets of resources or resource modules (also referred to as “pods”). Each resource module or pod may comprise a pre-integrated and optimized combination of resources of one or more types. In certain embodiments, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users or customers of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a customer may, using a client device, request (service request 634) one or more services provided by cloud infrastructure system 602 using one or more of interfaces 614, 616, and 618. For example, a customer may access the online store, browse cloud services offered by cloud infrastructure system 602, and place a subscription order for one or more services offered by cloud infrastructure system 602 that the customer wishes to subscribe to. The service request may include information identifying the customer and one or more services that the customer desires to subscribe to. For example, a customer may place a subscription order for a predictive analysis-related service offered by cloud infrastructure system 602. As part of the order, the customer may provide information identifying data sources 105, for example.

In certain embodiments, such as the embodiment depicted in FIG. 6, cloud infrastructure system 602 may comprise an order management subsystem (OMS) 620 that is configured to process the new order. As part of this processing, OMS 620 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

Cloud infrastructure system 602 may send a response or notification 644 to the requesting customer to indicate when the requested service is now ready for use. In some instances, information (e.g., a link) may be sent to the customer that enables the customer to start using and availing the benefits of the requested services. In certain embodiments, for a customer requesting the predictive analysis-related services, the response may include providing a user interface including, for example, graph 400 of FIG. 4.

Cloud infrastructure system 602 may provide services to multiple customers. For each customer, cloud infrastructure system 602 is responsible for managing information related to one or more subscription orders received from the customer, maintaining customer data related to the orders, and providing the requested services to the customer. Cloud infrastructure system 602 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 602 may provide services to multiple customers in parallel. Cloud infrastructure system 602 may store information for these customers, including possibly proprietary information. In certain embodiments, cloud infrastructure system 602 comprises an identity management subsystem (IMS) 628 that is configured to manage customers information and provide the separation of the managed information such that information related to one customer is not accessible by another customer. IMS 628 may be configured to provide various security-related services such as identity services, such as information access management, authentication and authorization services, services for managing customer identities and roles and related capabilities, and the like.

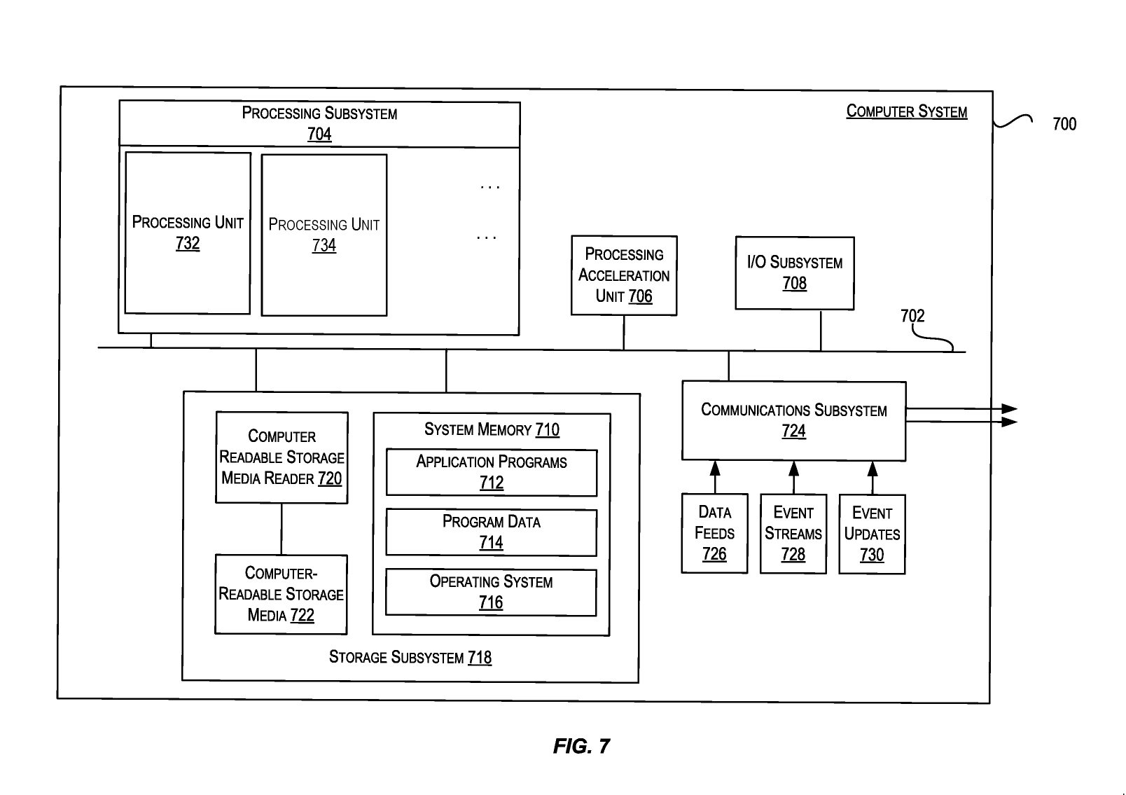

FIG. 7 illustrates an exemplary computer system 700 that may be used to implement certain embodiments. For example, in some embodiments, computer system 700 may be used to implement any of the data processing system 120 or various servers and computer systems described above. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative embodiments of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may include be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some embodiments, processing subsystem 704 can include one or more special purpose co-processors such as graphics processors, digital signal processors (DSPs), or the like. In some embodiments, some or all of the processing units of processing subsystem 704 can be implemented using customized circuits, such as application specific integrated circuits (ASICs), or field programmable gate arrays (FPGAs).

In some embodiments, the processing units in processing subsystem 704 can execute instructions stored in system memory 710 or on computer readable storage media 722. In various embodiments, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain embodiments, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some embodiments. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 722 may store programming and data constructs that provide the functionality of some embodiments. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, DVD, a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 718 may also include a computer-readable storage media reader 720 that can further be connected to computer-readable storage media 722. Reader 720 may receive and be configured to read data from a memory device such as a disk, a flash drive, etc.

In certain embodiments, computer system 700 may support virtualization technologies, including but not limited to virtualization of processing and memory resources. For example, computer system 700 may provide support for executing one or more virtual machines. In certain embodiments, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices. For example, the communication subsystem may be used to allow communication between data sources 105, data processing system 120, user systems 110, and/or database 115.

Communication subsystem 724 may support both wired and/or wireless communication protocols. For example, in certain embodiments, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments communications subsystem 724 can provide wired network connectivity (e.g., Ethernet) in addition to or instead of a wireless interface.

Communication subsystem 724 can receive and transmit data in various forms. For example, in some embodiments, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain embodiments, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art will appreciate other ways and/or methods to implement the various embodiments.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method comprising:
generating, by a computer system, a dynamic dependency model using a first set of time-series data, wherein the dynamic dependency model defines a plurality of relationships between a plurality of variables related to an enterprise, and wherein the first set of time-series data is collected for a first time period;
generating, by the computer system, a prediction of a first plurality of values of a first variable of the plurality of variables based on the dynamic dependency model, wherein the first plurality of values are predicted for a second time period;
obtaining, by the computer system, a plurality of actual values of the first variable during the second time period;
comparing, by the computer system, the first plurality of values with the plurality of actual values to generate a statistical deviation;
identifying, by the computer system, the statistical deviation as an anomaly; and
transmitting, by the computer system, a notification of the anomaly to a user device.

2. The method of claim 1, wherein the determining that the statistical deviation exceeds the threshold comprises:
generating, by the computer system, a second prediction of a second plurality of values of the first variable and a target value of the first variable based on the dynamic dependency model, wherein the second plurality of values are predicted for a third time period and the target value is predicted at an end of the third time period, wherein the third time period is after the second time period;
generating, by the computer system, a third prediction of a third plurality of values of the first variable and a predicted value of the first variable based on the plurality of actual values, wherein the third plurality of values are predicted for the third time period and the predicted value is predicted at the end of the third time period;
determining, by the computer system, that a difference between the target value of the first variable and the predicted value of the first variable exceeds a dynamically determined threshold value; and
generating, by the computer system, a confidence interval of the difference using the second plurality of values and the third plurality of values.

3. The method of claim 2, wherein the notification comprises a message reporting the difference and the confidence interval.

4. The method of claim 1, further comprising:
periodically updating, by the computer system, the dynamic dependency model using a more recent set of time series data.

5. The method of claim 1, wherein a measure of cross-entropy is further used to generate the statistical deviation.

6. The method of claim 1, wherein generating the dynamic dependency model comprises:
using a time window to limit the first set of time-series data;
assigning a weight to each value of the first set of time series data, wherein the weight assigned to each value decreases as an age of the value increases; and
using cross entropy between the plurality of variables to find relationships between combinations of the variables.

7. A non-transitory computer-readable memory storing a plurality of instructions executable by one or more processors, the plurality of instructions comprising instructions that when executed by the one or more processors cause the one or more processors to perform processing comprising:
generating a dynamic dependency model using a first set of time-series data, wherein the dynamic dependency model defines a plurality of relationships between a plurality of variables related to an enterprise, and wherein the first set of time-series data is collected for a first time period;
generating a prediction of a first plurality of values of a first variable of the plurality of variables based on the dynamic dependency model, wherein the first plurality of values are predicted for a second time period;
obtaining a plurality of actual values of the first variable during the second time period;
comparing the first plurality of values with the plurality of actual values to generate a statistical deviation;
determining that the statistical deviation exceeds a threshold; and
transmitting a notification of the statistical deviation to a user device.

8. The non-transitory computer-readable memory of claim 7, wherein the plurality of instructions for determining that the statistical deviation exceeds the threshold further comprises instructions that when executed by the one or more processors cause the one or more processors to perform processing comprising:
generating a second prediction of a second plurality of values of the first variable and a target value of the first variable based on the dynamic dependency model, wherein the second plurality of values are predicted for a third time period and the target value is predicted at an end of the third time period, wherein the third time period is after the second time period;
generating a third prediction of a third plurality of values of the first variable and a predicted value of the first variable based on the plurality of actual values, wherein the third plurality of values are predicted for the third time period and the predicted value is predicted at the end of the third time period;
determining that a difference between the target value of the first variable and the predicted value of the first variable exceeds a threshold value; and
generating a confidence interval of the difference using the second plurality of values and the third plurality of values.

9. The non-transitory computer-readable memory of claim 8, wherein the notification comprises a message reporting the difference and the confidence interval.

10. The non-transitory computer-readable memory of claim 7, wherein the plurality of instructions further comprises instructions that when executed by the one or more processors cause the one or more processors to perform processing comprising:
periodically updating the dynamic dependency model using a more current set of time series data.

11. The non-transitory computer-readable memory of claim 7, wherein a measure of cross-entropy is further used to generate the statistical deviation.

12. The non-transitory computer-readable memory of claim 7, wherein the plurality of instructions for generating the dynamic dependency model further comprises instructions that when executed by the one or more processors cause the one or more processors to perform processing comprising:
using a time window to limit the first set of time-series data;
assigning a weight to each value of the first set of time series data, wherein the weight assigned to each value decreases as an age of the value increases; and
using cross entropy between the plurality of variables to find relationships between combinations of the variables.

13. A system comprising:
one or more processors;
a memory coupled to the one or more processors, the memory storing a plurality of instructions executable by the one or more processors, the plurality of instructions comprising instructions that when executed by the one or more processors cause the one or more processors to perform processing comprising:
generating a dynamic dependency model using a first set of time-series data, wherein the dynamic dependency model defines a plurality of relationships between a plurality of variables related to an enterprise, and wherein the first set of time-series data is collected for a first time period;
generating a prediction of a first plurality of values of a first variable of the plurality of variables based on the dynamic dependency model, wherein the first plurality of values are predicted for a second time period, wherein the second time period is after the first time period;
obtaining a plurality of actual values of the first variable during the second time period;
comparing the first plurality of values with the plurality of actual values to generate a statistical deviation;
determining that the statistical deviation exceeds a threshold; and
transmitting a notification of the statistical deviation to a user device.

14. The system of claim 13, wherein the plurality of instructions for determining that the statistical deviation exceeds the threshold further comprises instructions that when executed by the one or more processors cause the one or more processors to perform processing comprising:
generating a second prediction of a second plurality of values of the first variable and a target value of the first variable based on the dynamic dependency model, wherein the second plurality of values are predicted for a third time period and the target value is predicted at an end of the third time period, wherein the third time period is after the second time period;
generating a third prediction of a third plurality of values of the first variable and a predicted value of the first variable based on the plurality of actual values, wherein the third plurality of values are predicted for the third time period and the predicted value is predicted at the end of the third time period;
determining that a difference between the target value of the first variable and the predicted value of the first variable exceeds a threshold value; and
generating a confidence interval of the difference using the second plurality of values and the third plurality of values.

15. The system of claim 14, wherein the notification comprises a message reporting the difference and the confidence interval.

16. The system of claim 13, wherein the plurality of instructions further comprises instructions that when executed by the one or more processors cause the one or more processors to perform processing comprising:
periodically updating the dynamic dependency model using a more current set of time series data.

17. The system of claim 13, wherein a measure of cross-entropy is further used to generate the statistical deviation.

18. The system of claim 13, wherein the plurality of instructions for generating the dynamic dependency model further comprises instructions that when executed by the one or more processors cause the one or more processors to perform processing comprising:
using a time window to limit the first set of time-series data;
assigning a weight to each value of the first set of time series data, wherein the weight assigned to each value decreases as an age of the value increases; and
using cross entropy between the plurality of variables to find relationships between combinations of the variables.
